(19) United States
(12) Patent Application Publication
(10) Pub. No.: US 2026/0331976 A1
(43) Pub. Date: Oct. 22, 2026

(54) AIR CORE, AXIAL OR RADIAL GAP PERMANENT MAGNET GENERATOR

(71) Applicant: Albert Stanley Vendel, Denver, CO (US)

(72) Inventor: Albert Stanley Vendel, Denver, CO (US)

(21) Appl. No.: 19/548,807

(22) Filed: Feb. 24, 2026

Related U.S. Application Data
(60) Provisional application No. 63/763,646, filed on Feb. 26, 2025.

(51) Int. Cl. H02K 1/27; H02K 3/04; H02K 7/00; H02K 11/00

(52) U.S. Cl. CPC H02K 1/27; H02K 3/04; H02K 7/003; H02K 11/0094

(57) ABSTRACT

An air core permanent magnet machine with a stator containing windings located circumferentially along an annular ring affixed about a central axis. Axially or radially spaced within the stator windings is a single rotor with magnets affixed along an inner annular ring at regular intervals. The rotor is connected to a central shaft that is supported by bearings in a housing to allow free rotation about the shaft axis. The stator windings are positioned to create two air gaps axially, or radially, about the rotor and present a high percentage of active coil volume aligned parallel to the magnet orientation. The magnet orientation and rotor movement create changing transverse magnetic flux perpendicular to the stator windings.

This application claims the benefit of U.S. Provisional App. 63/763,646, filed Feb. 25, 2025.

### BACKGROUND

Air core, axial flux, permanent magnet (PM) machine designs have proven to be effective electric generators and high-performance motors in use for decades, with many variations over that time. The air core aspect provides less cost and weight for magnetic material in the stator, less eddy current loss, simpler production, and results in less inertial drag on the rotor. Axial arrangement of the stator and rotor affords easier production and higher flexibility for expansion of the machine output.

Over the years, many improvements have been made in components and production processes while some design principles have remained unchanged. Many designs utilize opposing sets of magnets with a flat coil between, where the coil has a significant volume of winding material not aligned perpendicular to the varying magnetic flux. Therefore, there is room for improvement in the optimization of the percentage of active volume of windings exposed to the flux. It is proposed that the geometry of windings and magnets presented here will utilize less PM material and similar or less winding volume for power output comparable to present machines. The simple design lends itself to easier production processes and flexibility for scaleup and therefore a more economical and efficient product overall.

### SUMMARY

An exemplary embodiment of the invention comprises a single air core stator with multiple windings and a single rotor with multiple permanent magnets (PM) or electromagnets attached. The invention is to be used for converting rotational energy to electrical energy (generator) or electrical energy to rotational energy (motor). This presentation will focus on use as a generator, but it should be understood the reverse is possible. The machine comprises a single stationary stator with multiple windings of suitable material mounted in a circumferential manner on a nonmagnetic annular ring support within a housing. The stator windings are produced in a specific geometry to be matched with the magnet dimensions.

A single rotor comprised of a nonmagnetic metal disc machined or otherwise formed, or a molded, machined or 3D printed plastic disc, or a composite disc or a hub and spoke arrangement with annular sections. The rotor has multiple permanent magnets or electromagnets arranged along a ring shape and has a slightly smaller diameter than the stator. The rotor is mounted to a central shaft that is supported by bearings in the housing and free to rotate within axial air gaps formed between the legs or coils of the windings. The magnets and windings are shaped so that their radial lengths are essentially matched, so that the active volume of winding material is maximized to the area swept by the changing transverse magnetic flux. As positioned, the greatest percentage of total winding length is parallel to the length of the magnet and therefore exposes the highest percentage of winding material to the changing transverse magnetic flux as the rotor rotates. The magnets are placed with the poles perpendicular to the rotation axis and therefore produce a sinusoidal output for each pass of a magnet through each winding.

The stator windings can be composed of traditional insulated copper or a variety of other materials such as aluminum, copper-clad aluminum or other coated inductor metals. The machine design with a flange mounted hub is easily adjustable for different densities, winding geometries and material properties to make an economical combination for the needed output. The windings can be molded to shape or formed on a jig and mechanically attached or bonded to the stator support which has radial ridges to hold the windings in proper orientation to the magnet flux. The stator support can be machined from plastic or nonmagnetic metals or may be 3D printed.

The exemplary embodiment of this invention is a stator that would contain a quantity of windings that would cover an annular area approximately two thirds of the area swept by the rotor. This would facilitate lower inertial startup torque for the rotor movement. The windings are grouped together next to each other in sections to take advantage of the induced magnetic fields of one coil creating more flux in the adjacent winding. The quantity of windings used is a function of the device diameter, coil size and required coil leg spacing of one to four times the magnet width along the axis of magnetization. Additional windings can easily be added for higher output where startup torque is not an issue. The generator can be driven by typical renewable energy sources such as wind, hydro, tidal, gravity, etc. or traditional motors.

The coil end connections can be routed through microprocessor-controlled switches to facilitate maximized power output through control algorithms. A hybrid version could include a solar panel to provide additional acceleration to the rotor during periods of low driving force or to overcome inertial forces.

Further aspects of the exemplary embodiment of the invention include an axial gap generator device with a rotor containing permanent magnets or electromagnets and arranged for rotation within a stator having U shaped coils arranged on opposite sides of the rotor and electrically connected together to provide a common current direction through both U-shaped coils.

The rotor can be attached via spokes and an adjustable hub to a rotating shaft. The magnets can be mounted in a solid lightweight disc constructed of plastic, composite or nonmagnetic metal.

The coils can have windings made of insulated aluminum wire, copper clad aluminum, or other types of suitable coated metallic wires or ribbons. The coil windings can be molded to consistent dimensions with a suitable potting compound to facilitate air gap maintenance.

The number of coils can be restricted to a set quantity in precise geometric locations to reduce the number of magnets in active magnetic contact with the coils at each instance to reduce the amount of torque for startup and operation.

Coil connections can be routed through a switching apparatus controlled by a microprocessor. This microprocessor can be utilized to optimize the generator performance by switching coils on or off in series or parallel and adjust to the parameters of the driving forces.

A solar panel can be added to provide additional startup torque and extra driving force when the primary driving force is not sufficient for optimum performance. The device can be installed in a hybrid or electric vehicle to provide an auxiliary energy source for range extension or emergency use.

Numerous other advantages and features of the present invention will become readily apparent from the following detailed description of the invention and the embodiments thereof, from the claims and from the accompanying drawings.

### BRIEF DESCRIPTION OF DRAWINGS

FIG. 1 shows a top view (with cutaways) of exemplary embodiment generator machine, with rotor magnets on a hub and spoke support and a small section of stator windings with only the upper stator support shown with a cutaway view of the windings.

FIG. 2 is a sectional view of the machine of FIG. 1 showing the orientation within the air gaps.

FIG. 3 is a schematic diagram showing one set of upper and lower coils of the machine of FIG. 1 interacting with one magnet during rotation of the rotor within the stator.

FIG. 4 is a schematic diagram showing the one set of upper and lower coils of the machine of FIG. 1 taken generally through view 4-4, of FIG. 3, interacting with one magnet during rotation of the rotor within the stator.

FIG. 5 is a plan view of an alternate permanent magnet configuration.

FIG. 6 is a plan view of a further alternate permanent magnet configuration.

FIG. 7 is a sectional view of an alternate machine as a radial configuration showing the orientation within the air gaps.

### DETAILED DESCRIPTION

While this invention can be realized in a variety of forms, there are shown in the drawings, and will be described herein in detail, a specific embodiment for an improved air core, axial gap permanent magnet generator with the understanding that the present disclosure exemplifies the principles of the invention and is not intended to limit the invention to this specific form or application.

This application claims the benefit of U.S. Provisional App. 63/763,646, filed Feb. 25, 2025 which is incorporated by reference in its entirety.

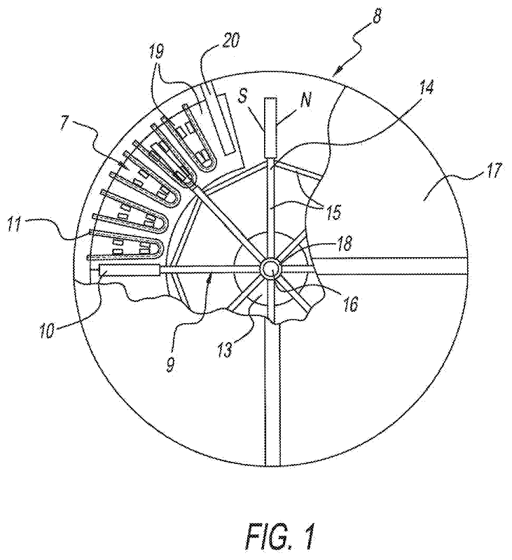

One embodiment of an exemplary embodiment generator machine 8 is shown in FIG. 1 having a rotor 9, within a housing 17, in which rotor magnets 10 are held in place by a hub 13 and spokes 14 and reinforcing braces 15. The hub 13 is fixed to a shaft 16 contained in the housing 17, which rotates the hub 13, and the rotor 9. The shaft 16 is rotated about its axis by an external power (not shown), such as from a gas engine, renewable energy driving forces, or the like. The spokes 14 attach to the hub 13. A stator 7 is mounted within the housing 17. The shaft 16 of the rotor is contained in the housing 17 through bearings 18. Magnets 10 are mechanically attached or bonded to the spokes 14. The stator 7 includes stator windings 11 mounted to top and bottom supports 19 which are made in sections to be placed at proper positions along the path of the rotor magnets 10. The lower support is mechanically attached directly to the housing while the upper support is anchored to the housing via brackets 20. Stator supports are manufactured by machining, molding or 3D printing to contain radial ridges to restrict the windings to the proper orientation to the magnet path. The windings themselves are wound or molded to the proper dimensions and mechanically fastened or bonded to the supports.

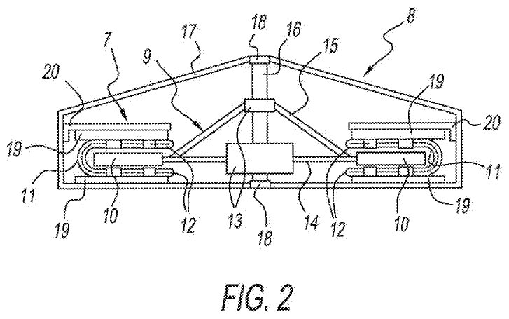

FIG. 2 shows a sectional view of the machine 8. The magnets 10 are rotated through the two U-shaped coils, an upper U-shaped coil 11a and a lower U-shaped coil 11b of each winding 11, with the magnetic axis of the magnets (from S to N) parallel to the planes of the U-shaped coils, both shown as horizontal in FIG. 2. Two airgaps 12 are maintained between the upper U-shaped coil 11a and the magnet and between the lower U-shaped coil 11b and magnet, and a sinusoidal output is achieved with each magnet pass. This arrangement maximizes the percentage of coil volume influenced by the changing magnetic flux and reduces the number of magnets needed compared to past designs for a given output.

Hub 13, spokes 14 and braces 15 serve to maintain the rotor 9 in a fixed horizontal plane to keep the airgaps consistent while the shaft 16 rotates in upper and lower bearings 18 within the housing 17. Upper and lower coil supports 19 are attached directly to the housing or via brackets 20 to hold the coils in proper position. The supports 19 can be plastic or metal machined, or otherwise formed, armature supports, or molded, machined or 3D printed plastic armature supports, or composite armature supports, to support the U-shaped coils.

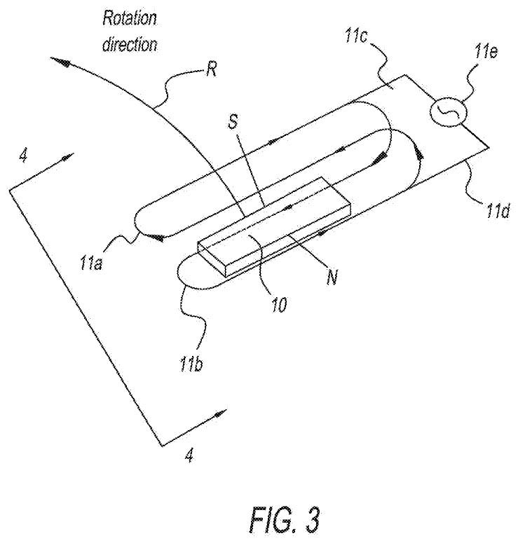

FIG. 3 illustrates one winding 11 having the upper U-shaped coil 11a and a lower U-shaped coil 11b wound together as one coil in a serpentine fashion. For a rotation shown as R, the instantaneous current direction in the winding 11 is shown by arrows. As the magnet 10 passes through the winding 11 between the upper coil 11a and the lower coil 11b the direction of current reverses and a substantially sinusoidal alternating current is generated at the output wires 11c, 11d indicated by the meter 11e. The direction of rotation of the rotor does not matter as it generates an alternating current.

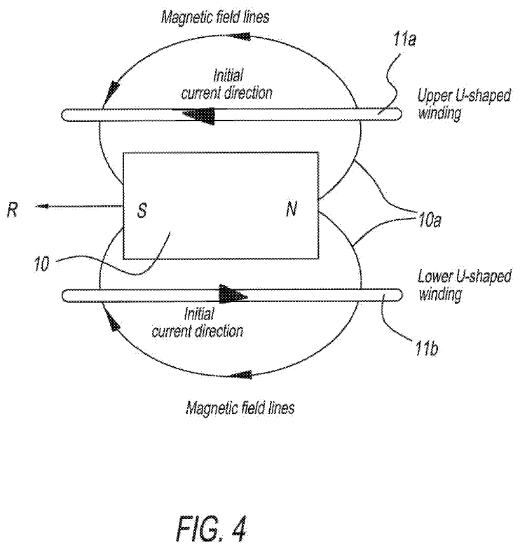

FIG. 4 illustrates the instantaneous current direction of FIG. 3 with arrows. As the magnet 10 passes through the winding 11 between the upper coil 11a and the lower coil 11b the direction of current reverses and a substantially sinusoidal alternating current is generated at the output wires 11c, 11d (FIG. 3) indicated by the meter 11e (FIG. 3).

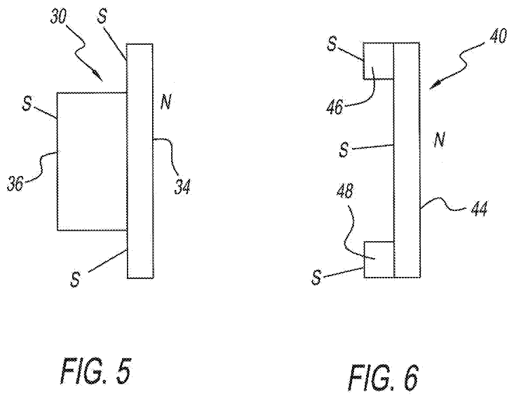

FIG. 5 illustrates an alternate permanent magnet configuration 30 to the heretofore described magnets 10, comprising an elongated magnet 34 and a shorter, wider magnet 36 stacked horizontally thereon.

FIG. 6 illustrates a further alternate embodiment permanent magnet configuration 40 to the heretofore described magnets 10, comprising a long magnet 44 and two shorter magnets 46, 48 stacked horizontally on the magnet 44, each placed at a radial end of the magnet 44.

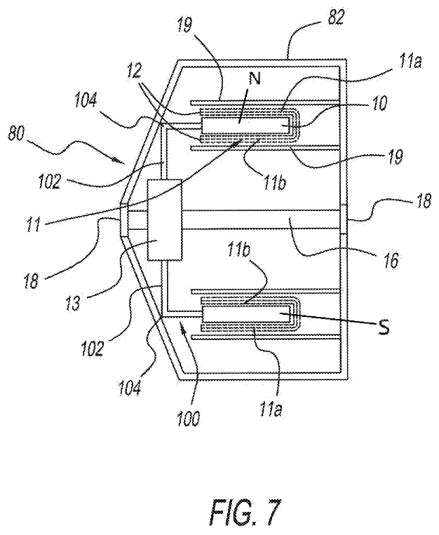

FIG. 7 shows a sectional view of an alternative machine 80 to the machine 8. The magnets 10 are rotated through the two U-shaped coils, an outer U-shaped coil 11a and an inner U-shaped coil 11b of each winding 11, with the magnetic axis of the magnets (from S to N) parallel to the planes of the U-shaped coils, both shown as horizontal in FIG. 7. Two radial airgaps 12 are maintained between the outer U-shaped coil 11a and the magnet and between the inner U-shaped coil 11b and magnet, and a sinusoidal output is achieved with each magnet pass. This arrangement maximizes the percentage of coil volume influenced by the changing magnetic flux and reduces the number of magnets needed compared to past designs for a given output.

Hub 13 and a rotor 100, having spokes 102, serve to maintain the magnets 10 at a fixed radial position from the shaft 16 to keep the air gaps consistent while the shaft 16 rotates in left and right bearings 18 within a housing 82. Outer and inner coil supports 19 are attached directly to the housing 82 or via brackets to hold the coils in proper position. The supports 19 can be a plastic or metal machined armature support to support the U-shaped coils. One difference between the embodiment of FIG. 2 and FIG. 7 is that the spokes 102 are bent at 90 degrees at a point 104 in order to bring the magnets parallel to, and closer to the shaft 16. This makes the housing 82 more compact.

The details in FIGS. 3-6 also pertain to the embodiment of FIG. 7.

Another embodiment utilizes a solid disc, or cylinder for a radial configuration, for the rotor 9 or 100 in which the magnets are mounted in machined or laser cut slots in the disc or cylinder. In both versions the hub attachment to the shaft is kept free to be adjusted along the shaft to allow for variations in winding materials and resultant dimensions of the coil geometry. For instance, coils of aluminum wire would require more volume than copper, and therefore the rotor position would have to be adjusted to compensate for the increased axial dimension.

A further embodiment utilizes a microprocessor to control the switching of individual coils or groups of coils to maximize efficiency through adjusting for operating conditions and output requirements. For example, several coils may be switched off at times to allow higher rotational speed and thereby increase output at a higher voltage through the remaining connected coils.

A hybrid drive version could be a wind turbine with an added solar panel and operation would be controlled by a microprocessor to maximize output according to the environmental conditions. Because of the device design having lower weight and size requirements the hybrid version or first embodiment may be useful in an electric vehicle to increase intrinsic range.

Permanent magnets can be replaced or augmented with electromagnets in all embodiments along with the associated control circuitry for the field coils.

From the foregoing, it will be observed that numerous variations and modifications may be effectuated without departing from the spirit and scope of the invention. It is to be understood that no limitation with respect to the specific apparatus illustrated herein is intended or should be inferred.

The invention claimed is:

1. An axial, or radial, gap generator device with a rotor containing permanent magnets or electromagnets and arranged for rotation within a stator having U shaped coils arranged on opposite sides of the rotor and electrically connected together to provide a common current direction through both U-shaped coils.

2. A device as in claim 1, wherein the rotor is attached via spokes from a hub on a rotating shaft.

3. A device as in claim 1, where the magnets are mounted in a solid lightweight disc constructed of plastic, composite or nonmagnetic metal.

4. A device as in claim 1, wherein each coil has windings made of coated metallic wires or ribbons.

5. A device as in claim 1, wherein the winding comprises insulated aluminum wire, or copper clad aluminum.

6. A device as in claim 1, wherein the coil windings are molded to consistent dimensions with a potting compound to facilitate air gap maintenance.

7. A device as in claim 1, wherein the coils have coil connections routed through a switching apparatus controlled by a microprocessor to optimize the generator performance by switching coils on or off in series or parallel and adjust to the parameters of the driving forces.

8. A device as in claim 1, further comprising a solar panel to provide additional startup torque and extra driving force.

9. A device as in claim 8, configured to be installed in a hybrid or electric vehicle to provide an auxiliary energy source for range extension or emergency use.

10. A device as in claim 1, configured to be used in a hybrid or electric vehicle to provide an auxiliary power source for range extension or emergency use.

11. A device as in claim 1, wherein the gap between respective coils and the permanent magnets or electromagnets is an axial gap according to the spinning axis of the rotor.

12. A device as in claim 11, wherein the rotor is attached via radially extending spokes from a hub on a rotating shaft.

13. A device as in claim 1, wherein the gap between respective coils and the permanent magnets or electromagnets is a radial gap according to the spinning axis of the rotor.

14. A device as in claim 13, wherein the rotor is attached via radially and axially extending spokes from a hub on a rotating shaft.

15. A device as in claim 1, wherein the permanent magnets or electromagnets are permanent magnets and each comprise an elongated magnet and a shorter, thicker magnet stacked thereon.

16. A device as in claim 1, wherein the permanent magnets or electromagnets are permanent magnets comprising an elongated magnet and two shorter magnets stacked thereon at opposite ends of the elongated magnet.
